(19) United States
(12) Patent Application Publication
(10) Pub. No.: US 2002/0146952 A1
(43) Pub. Date: Oct. 10, 2002

(54) Nonwoven backing especially for adhesive tape with improved hand tearability

(76) Inventors: Klaus Kulper, Pinneberg (DE); Frank Lange, Hamburg (DE); Andre Overkamp, Gronau-Epe (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/076,796

(22) Filed: Feb. 15, 2002

(30) Foreign Application Priority Data
Mar. 15, 2001 (DE) 101 12 375.2

(51) Int. Cl. B32B 27/04; B32B 5/12; B32B 27/12; D04H 3/00; D04H 13/00; D04H 5/00; D04H 1/00; B32B 5/02

(52) U.S. Cl. 442/150; 442/327; 442/149

(57) ABSTRACT

Nonwoven-based backing material especially for adhesive tape, comprising a tape-shaped nonwoven-based backing having at least one polymer-base stripe surficially applied to it on either or both of its sides.

This invention relates to a nonwoven-based backing material especially for adhesive tape that is notable for improved hand tearability.

Adhesive tapes having woven and loop-formingly knitted backings have been used for decades not only in medical applications and as universal adhesive tapes but also for specific engineering applications. They are valued here especially not only for textile character and quality, high tensile strengths and flexibilities but also for the actually surprising property of the adhesive tape possessing manual transverse tearability, which is provided by a suitable choice of yarn material, yarn linear density and fabric construction. This property of being able to be torn off in arbitrary lengths is of advantage not only in industrial manufacturing processes such as for example the winding of automotive cable harnesses but also in doctors' surgeries and hospitals and also in consumer applications such as handicrafts, since it means that it is possible to dispense with tools such as scissors, blades, dispensers, etc., which are first not always available but secondly whose mandatory use can be a nuisance especially in working routines on industrial fabrication lines.

Since woven fabrics are and will for the foreseeable future remain costly owing to the slow and inconvenient production technology of weaving, there has been an intensified search on in recent years for alternative backings for adhesives tapes and plasters. Nonwoven fabrics composed of filaments or fibers of finite length are an obvious alternative and have already found appreciable use in medical applications in particular. Similarly, nonwoven adhesive tapes are already in use as engineering adhesive tapes for example for the winding of cable harnesses or electrical coils and transformers. Nonwoven fabrics are not only able to function as a woven fabric replacement on a large scale, but are frequently custom tailorable, and then offer additional properties which are unattainable with woven fabrics.

The use of nonwoven fabrics is associated with an appreciable cost advantage over woven or loop-formingly knitted backings, since modern manufacturing processes for spunbonded or staple fiber nonwoven fabrics are more productive by orders of magnitude, and the manufacturing technologies which are in use for for example spunbondeds or hydroentangled or thermal-bonded staple fiber webs still harbor huge process optimization potentials.

Generally, however, nonwoven fabrics are inferior to woven fabrics with regard to the relationship of physical strengths (tensile strength, delamination resistance, tear strength) to textile properties (such as hand, fuzziness, flexibility, softness, etc.). When nonwoven fabrics are soft and fuzzy as in the case of filter nonwovens and are easy to tear off by hand, however, they are unsuitable for adhesive tape applications. The low tensile strengths in the machine direction (MD) do not permit consistent processing from reel to reel during manufacture, nor can the end user use such adhesive tapes for example for bandages and fastenings involving relatively high tensile loads. The low bond strength of nonwoven fabrics makes problems likely such as delamination of the backing as the adhesive tape is unwound from the reel; moreover, the adhesive tape is at least appreciably limited in its adhesive performance when loose or only lightly held fibers or filaments are pulled out of the web surface in the course of unwinding from the reel and remain on the adhesive layer; finally, manual tearing in the case of such nonwoven fabrics will generally result in a visually unattractive, frayed tear line.

Conversely, sufficiently intensive consolidation of nonwoven fabrics makes it possible to create firm and compact backings which, however, are usually markedly harsher, stiffer and boardier than woven fabrics and which do not permit easy manual tearability without tools. Moreover, intensive web consolidation would reduce further advantageous traits of fuzzy nonwoven fabrics over woven fabrics such as for example the soft and pleasant hand and also the pronounced noise dampening ability—properties which explain why in the automotive industry in particular there is a preference for nonwoven adhesive tapes over woven adhesive tapes in quite a few application areas such as for example bandaging of cable trunks.

However, especially the ability to tear a textile adhesive tape by hand transversely to the machine direction without additional tools such as scissors, blades, cutters or dispensers is an important and critical requirement: for a universal adhesive tape which has to be usable at any time even when no tools are at hand; similarly for an engineering adhesive tape in the winding and bandaging of electric cables to form complete cable trunks under piece rate work conditions, where the need to use scissors or the like would reduce productivity, since it disrupts the most efficient work routines.

This hand tearability has to meet two essential requirements, whose weighting with regard to each other can differ according to application: as a universal adhesive tape or, on the other hand, as a specialty adhesive tape for industrial use—for industrial applications such as for example cable bandaging where

tearing off must be easy and repeatable for hours without employee fatigue or overexertion; especially for consumer adhesive tapes, on the other hand,

an attractive tear is very important and should ideally be in a straight line, at right angles to the adhesive tape edge and without excessive fraying.

Both the requirements are very substantially met by a specifically consolidated nonwoven fabric, the Maliwatt fabric produced by web stitching with thread, or comparable embodiments, in that pronounced transverse orientation of the staple fibers provides favorable tearing performance in the transverse or cross direction and the overstitching with separately supplied threads in the machine direction MD ensures sufficient retention of fiber and tensile strength. Adhesive tapes having such a backing material are described in EP 0 668 336 A1 and also DE 44 42 092 C1 and are used especially in the production of automotive cable harnesses and as a universal adhesive tape.

However, the backing properties needed for an adhesive tape application require a multiplicity of stitches close together (high fineness) and also a short stitching length (spacing of needle entry points in stitching operation)—and both necessitate a very expensive production process which at about 1 to 2 m/min is slow and hence cost intensive—owing to the multiplicity of moving mechanical parts in such stitching machines significant improvements in the production speed are unlikely.

Other nonwoven fabrics which can be torn off by hand but which are prone to delamination and to fiber pullouts from the surface in adhesive tape use are, true, usable in principle for adhesive tapes when the corresponding adhesive tape is covered with an auxiliary backing such as for example siliconized release papers or films. However, this approach is adopted for adhesive tape reel material only in exceptional cases, since the manufacturing process becomes more expensive, the auxiliary backing represents an additional cost item, the handling of the adhesive tape becomes more difficult for the end user and appreciable waste quantities of release paper/film have to be disposed of. Furthermore, there are strict bans on the use of silicone-containing products in parts of the electronics and automotive industries in particular.

The use of wet-laid nonwoven fabrics makes it possible to obtain adhesive tapes having acceptable hand tearabilities in the transverse or cross direction, since wet-laid webs are produced from short fibers, usually from predominantly cellulosic fibers. While cellulosic fibers do provide appreciable web bond strengths via hydrogen bonds alone, the use of synthetic fibers requires additional consolidation techniques—the necessary fiber-fiber bonding is achieved predominantly through the use of dispersions as chemical binders; recently there has been an increasing trend toward the admixture of melt fibers or bicomponent fibers which in the course of an appropriate thermal treatment likewise lead to consolidation of the web assembly. However, the production process is such that wet-laid nonwovens are predominantly papery backing materials which lack the desired typical textile character and for example in cable trunk fabrication lead to creasing and bagging in the spiral winding operation, since they are not sufficiently extensible and conformable. Furthermore, the high proportion of viscose fibers often needed for the production process weakens the backing with regard to thermal stability and aging resistance, severely limiting utility as an engineering adhesive tape.

EP 0 821 044 A1 describes a packaging adhesive tape having good transverse tearability. It is formed by laminating a spunbonded having filaments aligned in the machine direction together with a second spunbonded having filaments aligned in the cross direction. The filaments have a linear density of not more than 1 denier [denier is the weight in g per 9000 m].

The laminating is preferably effected by thermal embossing, the embossed pattern having lines in the CD direction to improve the transverse tearability. Instead of the second spunbonded other transversely oriented fabrics are usable as well. The thermal embossing described and also an additional uniform coating of the top side with a synthetic resin layer not only complicate the manufacturing process, but change the esthetic and tactile properties of the backing from a textile in the direction of a plastic film.

In order nevertheless to be able to use “normal” nonwoven fabrics such as dry-laid staple fiber nonwovens for adhesive tape applications, U.S. Pat. No. 5,631,073 A1 describes a specific method of consolidation which not only improves the mechanical strength properties but also provides good hand tearabilities in the cross web direction. The nonwoven fabrics described consist of staple fibers and binder fibers and are pressure and heat embossed in a first step and then subsequently further consolidated by impregnation with a bonding agent and/or hydroentangling or needling. The embossing creates line structures in the cross web direction that are deemed essential for hand tearability. However, such thermal calendering markedly compacts the nonwoven backing and welds it together in the embossed areas, so that the backing becomes harsher and its textile properties deteriorate. Moreover, the complete processing operation of the invention to the finished backing nonwoven is extremely expensive and only justified for specific applications. So adhesive tapes of this kind have hitherto been used essentially only in the medical field, but could in principle also be utilized for engineering requirements and for universal adhesive tapes.

Similarly expensive and only justified in special cases is the production of a hand-tearable adhesive tape for medical applications that is described in WO 00/20201 A1. The backing is a laminate of two or three separate layers, one of which is a woven scrim while the other one or two layers are nonwovens. The nonwoven for this is preferably first thermally embossed as described in WO 93/15245 A1 to obtain cross web tearabilities that are already good. The laminate of the invention is subsequently formed by thermolamination of nonwoven and scrim and additional coating with chemical binder.

A more gradual improvement in hand tearability is also obtainable by consolidating “normal” carded staple fiber web materials using chemical binders or melt or binder fibers—such adhesive tapes are described in DE 199 23 399 A1 and DE 199 37 446 A1. In both cases, the additional binder systems are homogeneously distributed over the entire fiber assembly. Soft, elastic binder systems preserve textile properties such as softness, hand, etc., while hand tearability deteriorates if anything; in contrast, hard, brittle binder systems improve the mechanical strengths and also hand tearability, but the nonwoven becomes stiff and boardy—the desired textile properties for adhesive tape applications are adversely affected and when used for cable bandaging there is a risk of undesirable creasing in spiral winds.

U.S. Pat. No. 4,772,499 A1 provides an improvement in the CD tearability of a non-woven fabric by providing the fabric with a multiplicity of separate stripes or blocks which are preferably parallel to the CD direction and which are produced by depthwise impregnation of the entire thickness of the fabric with a binder. The binder-free regions between these impregnated cross-stripes are on the order of 1/16 inch [=1/16*25.4 mm=1.5875 mm] in size and narrower than the binder-consolidated regions, and this results in increased tensile strengths in the MD direction. The disclosed ratio between stripe width and separation is greater than 1, so that the predominant portion of the fabric is binder impregnated and consolidated. The massive concentration of chemical binder in the stripes over the full layer thickness and also the merely narrow nonimpregnated separations in between improve hand tearability in the cross direction and make a clean tear line between two bonded stripes likely, but also provide a harshened backing which is not advisable for adhesive tape applications where textile properties such as hand, softness and conformability are important.

It is likewise known that a uniform coating of nonwovens with a synthetic resin layer on one or both sides is a way of positively influencing the hand tearability, provided this coating is not excessively soft and elastic. Composites formed by direct extrusion of suitable polymers such as for example polyethylene or polypropylene onto textile supports such as woven, loop-formingly knitted and nonwoven fabrics are more easily tearable than the straight textile backings when the polymer film provides a certain hardness and brittleness—but unfortunately this also worsens the flexibility and conformability desired for the adhesive tape and in the case of the commonly employed PE coating limits the thermal and weather stability of the adhesive tape.

Similar improvements in hand tearability can be achieved by one- or two-sided coating with polymer dispersions or pastes and also by impregnating of nonwoven backings—described in DE 44 42 092 C1 for example—wherein the utilization of suitable polymer dispersions based on polyacrylates, polyurethanes and the like provide advantages in thermal and weather stability over the polyethylene and polypropylene coatings mentioned.

However, all these coatings of nonwoven fabrics require an additional process step, which can normally not be implemented on line in the course of fabric production. Such coatings add greatly to the cost of the end product and reduce the textile character of the nonwoven fabric.

Approaches to significantly improve the hand tearability of nonwoven fabrics in the cross web or transverse direction have hitherto been in line with the idea of constructing “lead structures” in the backing in the CD direction to orient and route the tearing action. In WO 00/20201 A1 these are the CD threads of the scrim, in U.S. Pat. No. 4,772,499 A1 they are the parallel stripes in the CD direction which are created by partial impregnation and in U.S. Pat. No. 5,631,073 A1 and also in EP 0 821 044 A1 they are the embossments having a preferred line structure in the cross direction. It is these lead structures which guide the process of tear propagation, so that there is little if any fraying produced given suitable achievement of the lead structures.

In contrast, known textile backing materials possessing good manual cross or transverse tearabilities such as woven fabrics, loop-formingly knitted fabrics, Maliwatt fabrics (web stitched with thread), etc. are characterized by a multiplicity of closely spaced threads in the machine direction; the weaving, formed-loop knitting and stitch bonding processes cause these sets of threads to be substantially immobilized in the fabric so that they are displaceable from their position only by appreciable application of force. Choosing the linear densities of the warp threads and of the stitching threads in the MD direction in such a way that the kind of abrupt loading which occurs on tearing will cause the thread to break rather than to become displaced in the fabric, achieves the property of hand tearability—whereas if the threads are too thick or else the geometric immobilization is too weak, the individual threads become pushed together on tearing to form thread bundles and then offer such a high resistance to tearing that the backing material will only be stretched, deformed and overextended but will not tear through in a substantially straight line—a portion of the energy input is lost in the deformation and distortion of the fabric and is not available for the tearing through.

It is an object of the present invention to provide a novel textile backing material on the basis of a nonwoven fabric especially comprising filaments or staple fibers that avoids the disadvantages of the prior art and that can be fabricated using modern, productive web production and finishing technologies and that exhibits not only substantial retention of textile character but also the important property for adhesive tapes of manual tearability in the transverse or cross direction.

This object is achieved by a backing material as set forth in the main claim. The subsidiary claims provide advantageous refinements of the backing material and also preferred uses for the backing material of the present invention.

The present invention accordingly provides nonwoven-based backing material especially for adhesive tape, comprising a tape-shaped nonwoven-based backing having at least one polymer-base stripe surficially applied to it on either or both of its sides.

It is surprising even to one skilled in the art that imitating the described warp threads possessing preferential orientation in the machine direction in the case of standard nonwoven fabrics by the application according to the invention of stripes which per se are difficult to hand tear if at all leads to a distinct improvement in the transverse tearability by hand and additionally improves the mechanical tensile strengths in the MD direction. Moreover, the invention substantially preserves the textile properties such as hand, flexibility, softness, etc., which is not the case with existing processes.

It was found that standard nonwoven fabrics as especially formed from staple fibers and consolidated using known technologies such as needling, hydroentangling, chemical bonding agents, thermal bonding and the like and which possess inadequate hand tearabilities in the transverse direction are distinctly improvable with regard to hand tearability while substantially preserving the textile properties as compared with the starting nonwoven. Unexpectedly, and contrary to the prior art, no cross direction lead structures had to be created for this in the nonwoven.

The stripes are used to imitate the sets of threads which in the case of hand-tearable textiles such as woven fabrics are achieved by the warp threads and in the case of stitch-bonded fabrics such as Maliwatt by the stitching threads—the printed stripes in the longitudinal direction act similarly to such sets of threads in the MD direction and bring about an increase in the MD tensile strength, since, first, the fibers in the printed region become more bonded to each other and, secondly, the stripes themselves constitute a strength-enhancing element.

In one advantageous embodiment of the invention, said backing supports a multiplicity of stripes which, moreover, may be applied in a parallel arrangement.

In a further advantageous embodiment, the stripes are applied substantially in the machine direction. It is particularly advantageous in this embodiment for the stripes to be completely oriented in the machine direction.

The stripes may comprise narrow lines or/and concatenated geometries such as for example rhombuses, ellipses and/or circles.

In a likewise preferred embodiment, the stripes are continuous or interrupted regularly or randomly by separations, the distances between the elements being smaller than the lengths of the stripe elements.

As well as the heretofore described thin stripes in the longitudinal direction, further geometries can be used to obtain improved hand tearabilities in the transverse direction—useful geometries for the purposes of the invention are substantially characterized by a marked preferential direction MD, which is present in pure form in the case of longitudinal stripes.

Possibilities instead of continuous stripes include partly interrupted stripes and also structures formed by concatination of shapes such as for example rhombuses, circles, ellipses. The larger the proportion of area covered and the larger the base areas of these foundation elements and the more the individual elements are directly connected to each other, the greater the degree of consolidation of the nonwoven fabric—the tensile strength increases when the tendency for individual fibers to pull out from the surface in adhesive tape applications decreases, but these improvements come at the expense of increasing harshening, so that the optimum balance of important backing properties is easily and effortlessly achievable by one skilled in the art on the basis of knowledge within the ambit of a person skilled in the art via the geometry, proportion of area covered and penetration depth of the binder print in accordance with the concrete requirement.

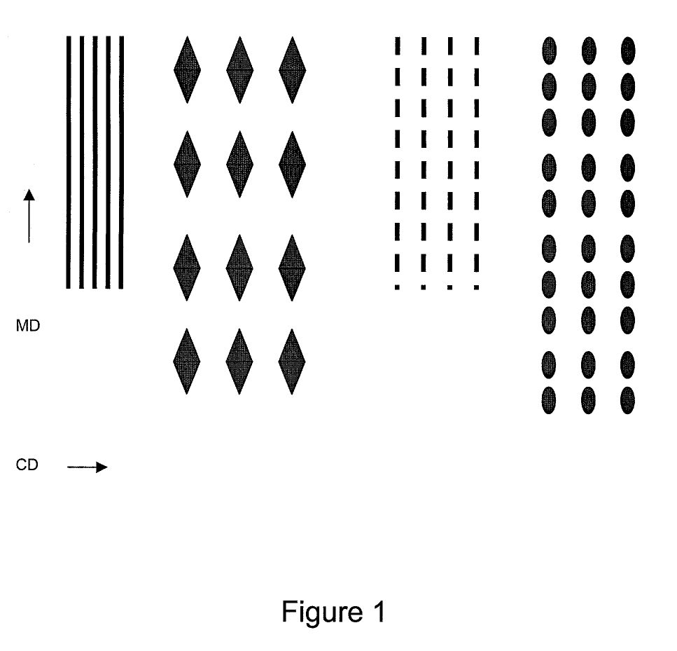

Typical examples of inventive geometries between a purely longitudinal orientation are given under FIG. 1 without any claim to completeness within the meaning of the invention.

In a further preferred embodiment, cross-stripes have been applied to the backing at substantially right angles to the stripes, so that it is even possible to utilize geometries which, as well as the dominant alignment in the longitudinal direction, also comprise small fractions in the transverse or skew direction (based on MD). Since the prior art lead structures in the transverse direction are not necessary for improving the hand tearabilities, the stripes etc. in the CD direction can be chosen to be substantially reduced in amount and size compared with the MD structures. This not only leads to a substantial saving of binder, but is also the only way of achieving the substantial preservation of the textile properties.

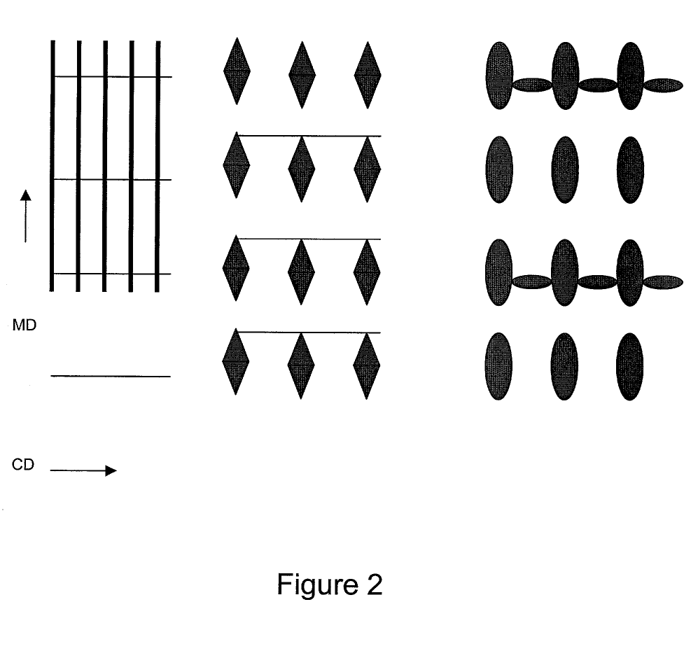

Typical examples of such geometries according to the invention are given under FIG. 2.

By for example providing few and thin stripes in the transverse direction, the hand tearability is not significantly further improved over a nonwoven fabric having purely MD stripes, yet the CD stripes provide a stabilization of the nonwoven fabric in the transverse direction that is desirable although not absolutely necessary for the production and use of adhesive tapes.

Preferably, the stripes according to the invention are applied by printing technologies such as photogravure or screen printing, by spraying techniques such as inkjet, partial impregnating, pressureless application from a casting head, jet stripe spread coating or knife coating.

Knife coating is effected using either a suitable mask for such geometries or else a backing base material already having grooves or channels in the longitudinal direction. These can be created by embossing or occur in hydroentangling as a normally undesirable effect of the last nozzle strip. Under appropriate water pressure, the last jets of water leave the moving web of nonwoven fabric with line-shaped depressions which can be filled with binder or printing ink by knife coating. Suitable lines in the longitudinal direction can be produced according to the basic concept of the invention not only by printing but also via embossing by means of temperature and/or pressure in the nonwoven backing.

In the preferred form, a multiplicity of parallel and/or narrow stripes are applied to the nonwoven fabric on one side thereof using printing processes such as screen printing or photogravure printing, since the necessary geometries and application rates are best achievable thereby. Moreover, there is extensive experience in printing textiles using these technologies.

Flexographic printing is also suitable for applying the desired geometries, but adequate fiber consolidation requires a higher application rate of binder than can normally be provided by this relief printing technique.

The number and the width of the stripes depend on the properties sought for the finished nonwoven fabric, but must also reflect the possibilities of the application techniques chosen.

In the case of printing technologies such as screen and photogravure printing, a suitable choice of “printing ink” makes it possible to print very fine stripes about 0.1 up to 6 mm in width, it being preferable to choose stripe widths of 0.5 to 3 mm.

In the case of the use of coating technologies such as casting head, knife coating, etc., the stripe width is limited at the lower end by the technologies chosen.

In order that the desired textile properties may be left substantially unchanged, one preferred embodiment has the separations between the printed stripes greater than stripe width, so that the proportion of area covered is below 50%. In other words, the total area of all stripes comprises less than 50% of the total area of said backing, especially from 20 to 40%.

In contrast to U.S. Pat. No. 4,772,499 A1, where complete through impregnation of the nonwoven fabric and more than 50%, in the examples in effect even more than 66%, proportion of area covered is stipulated, the necessary amount of binder is substantially reducible when tearable nonwoven fabrics are produced in a manner according to the invention.

First, area coverages of 5 to 50% are sufficient, the best results being obtained at 20 to 40%.

Secondly, the stipulated preservation of the textile properties means that non-complete through impregnation is sought; in the case of already thoroughly hydroentangled nonwoven fabrics, the best results are obtained when the binder is predominantly localized at the surface of the nonwoven base and the binder quantities substantially decrease from top to bottom over the thickness profile of the nonwoven fabric.

The printed stripes are locally immobilized similarly to the warp threads of woven fabrics or the stitching threads in the case of stitchbonded fabrics, and thus fulfill an essential requirement for good hand tearabilities.

It is further desired to have an adequate density for the stripes, in that a multiplicity of fine stripes give better results than few yet thicker stripes; in the latter cases, the edge of the tear line becomes ragged and in the case of very wide spacings there is even a danger that hand tearability is hardly improved and tear propagation is deflected from the transverse into the longitudinal direction.

The starting material can be a very wide range of nonwoven fabrics. Preferably they are staple fiber nonwovens formed from common natural or synthetic fibers and also fiber blends having fiber lengths in the range from 30 to 100 mm and/or fiber linear densities of 1 to6 dtex.

Fiber orientation can vary within wide limits between preferential longitudinal or transverse orientation or random, in which case a moderate longitudinal orientation having an MD:CD ratio of 1:1 to 5:1 is preferred, since the stripes print improves tensile strength in the longitudinal direction only and not in the transverse direction. When the fibers possess a strongly marked longitudinal orientation, the nonwoven fabric will lack strengths in the transverse direction which are not sufficiently elevated by the finishing of the invention and therefore make the use as an adhesive tape backing appear problematical owing to easy overstretching in the transverse direction.

Web laydown and consolidation can be effected using virtually all known, common techniques. However, since textile adhesive tapes are expected and required to have a typical textile character, nonwoven production is preferably effected using carded and hydroentangled web materials.

Compared with other proven technologies, hydroentangling offers the most favorable combination of mechanical strength (tensile strength and delamination resistance), fiber retention in the surface and textile properties such as soft hand, flexibility, etc., so that such backings are predestined for adhesive tape applications.

However, without additional finishing of such backing support, the desired property profile is unattainable—although suitable fiber type, fiber length and fiber linear density, different fiber laydown and consolidation can provide an appreciable range of nonwoven fabrics all these, however do not possess the required combination of mechanical strength and fiber fixation coupled with textile character and good hand tearability in the transverse direction with an attractive tear line. Viscose fiber material provides very fuzzy backings having improved hand tearabilities, but the mechanical strengths and the retention of surface fibers are unsatisfactory. Moreover, the use of viscose fibers would restrict the use of such nonwoven fabrics for engineering applications, since for example cable trunk adhesive tapes require higher thermal and moisture stabilities and also rotting resistance.

In one excellent embodiment of the invention, the polymer base used comprises binders, inks, including printing inks, coatings in the form of dispersions or pastes dissolved in organic solvents, as hotmelts or else as reactive systems such as for example radiation-chemically curable coatings, especially having main constituents such as polyacrylates, polyvinyl acetates, polyurethanes, polyesters, styrenic copolymers.

The polymers possess sufficient adhesion and affinity for the particular fibers used.

Furthermore, in an advantageous embodiment, the polymer base is applied to said backing at from 1 to 80 g/m² and especially at from 3 to 20 g/m², although these application rates depend substantially on the basis weight of the raw nonwoven used and are based on the entire backing with its printed and unprinted areas.

The binder or printing ink must be adapted not only to the coating technology used but also to the requirements of the nonwoven base.

In principle, manifold systems such as binders, inks, coatings in the form of dispersions or pastes dissolved in organic solvents, as hotmelts or else as reactive systems such as for example radiation-chemically curable coatings may be used. The main constituents of these binders, which form a coherent film when cured, are polymers such as for example polyacrylates, polyvinyl acetate, polyurethanes, styrenic copolymers. In addition, dyes and color pigments, stabilizers, wetting agents, crosslinkers, antioxidants, etc. can be present. The binder must be adapted to the fibers used, so that good wetting and, after curing, a permanent adhesion is achieved.

A particularly favorable choice in connection with the printing technologies of screen printing and photogravure printing is to use polymer dispersions of the kind known as chemical bonding agents in the nonwovens sector. Good fiber wetting and bonding can here be taken as given, and there is at least a choice of commercially available bonding dispersions for all commonly used fiber materials.

The viscosity of the dispersion is a way to control the depthwise penetration into the nonwoven and hence the additional consolidation—if a highly viscous paste is printed, the stripes are applied surficially to the surface and only the surface fibers bound—the textile strength increases only minimally and the original textile character is substantially preserved.

On printing thinly liquid dispersions, the blotting paper effect will cause the stripes to become broad, and the polymer will sink deeper into the nonwoven. This produces more fiber-fiber bonds and hence an increase not only in the tensile strength but also in the delamination resistance. If the polymer is substantially localized at the fiber-fiber nodes, the harshening of the nonwoven will stay within acceptable limits.

The technique for curing the binder after application is determined by the application form of the binder—dispersions and solutions are cured by drying in conventional assemblies, hotmelts by simply cooling to room temperature and radiation-curable coatings by crosslinking by means of UV light or other high-energy radiation.

Hydroentangled nonwovens are advantageously combinable with aqueous dispersions even at the production stage. The web, which is already moist owing to the consolidation with high-energy water jets, is roughly dewatered by passing it through a squeezing-off station and then printed using screen or photogravure printing. The viscosity of the dispersion is used to control the depthwise penetration and hence the extent of the three-dimensional consolidation. The drying of the nonwoven and also the curing of the binder is then efficiently and economically effected in one step together in conventional dryers.

The combination of hydroentangled nonwoven and dispersion printing is also advantageous against the background that this kind of web consolidation technique provides a usually already adequate delamination resistance (strength in the z-direction), which makes it possible to minimize the use of chemical bonding agents and predominantly do no more than surficially print the stripes structures without through impregnation, and this has a positive effect on the desired retention of the textile properties.

In a further preferred embodiment of the backing material, a self-adhesive composition has been applied to at least one side of said tape-shaped backing.

The backing material according to the invention is accordingly very useful for the production of an adhesive tape wherein stripes have been applied to one side of said tape-shaped backing and a self-adhesive composition has been applied, especially uniformly, to the other side, the side opposite the side with said stripe or stripes.

The coated backing material is particularly advantageous when used for wrapping elongate material, such as in particular cable trunks, which comprises said backing material being routed spirally around said elongate material.

To produce adhesive tapes, nonwoven fabrics according to the invention are in the course of the continued manufacturing operation conventionally at least one-sidedly coated with adhesives and if necessary covered with release paper and cut off for punching or else slit in the desired dimensions to form small rolls. The coating with the adhesive composition is normally effected one-sidedly on the printing-remote side, but can also be carried out in such a way that ultimately the printed binder geometries are localized as a partial intermediate layer between the nonwoven and the adhesive composition.

A useful self-adhesive composition is in particular a commercially available pressure-sensitive adhesive composition based on acrylate or rubber.

A particularly advantageous adhesive composition is an adhesive composition based on acrylate hotmelt and having a K value of at least 20, especially greater than 30, obtainable by concentrating a solution of such a composition to a system processible as a hotmelt.

The concentrating can take place in appropriately equipped kettles or extruders, a devolatilizing extruder being preferred during the associated devolatilization in particular. An adhesive composition of this kind is described in DE 43 13 008 A1. The acrylate compositions prepared in this way are completely stripped of the solvent in an intermediate step.

In addition, further volatiles are removed in the process. After coating from the melt, these compositions are left with only low levels of volatile constituents. Accordingly, all monomers/recipes claimed in the above-cited patent can be adopted. A further advantage of the compositions described in said patent is that these have a high K value and hence a high molecular weight. One skilled in the art knows that systems having higher molecular weights are more efficiently crosslinkable. This correspondingly reduces the fraction of volatile constituents.

The solution of the composition can contain 5 to 80% by weight and especially 30 to 70% by weight of solvent.

Preference is given to using commercially available solvents, especially low-boiling hydrocarbons, ketones, alcohols and/or esters.

It is further preferable to use extruders having one or two or more screws and one or especially two or more devolatilizing units.

The adhesive composition based on acrylate hotmelt can contain polymerized units derived from benzoin derivatives, for example benzoin acrylate or benzoin methacrylate, acrylic or methacrylic esters. Such benzoin derivatives are described in EP 0 578 151 A1. However, the adhesive composition based on acrylate hotmelt can also be chemically crosslinked.

In a particularly preferred embodiment, the self-adhesive compositions used are copolymers of (meth)acrylic acid and esters thereof having 1 to 25 carbon atoms, maleic, fumaric and/or itaconic acid and/or esters thereof, substituierted (meth)acrylamides, maleic anhydride and other vinyl compounds, such as vinyl esters, especially vinyl acetate, vinyl alcohols and/or vinyl ethers.

The residual solvent content should be below 1% by weight.

Low flammability is achievable for the adhesive tape described by adding flame retardants to the backing and/or the adhesive material. These flame retardants can be organobromine compounds, if necessary with synergists such as antimony trioxide, although preference is given to using red phosphorus, organophosphorus, mineral or intumescent compounds such as ammonium polyphosphate alone or in conjunction with synergists having regard to the absence of halogen from the adhesive tape.

Such adhesive tapes comprising nonwoven backing material produced according to the invention possess improved hand tearability in the transverse direction coupled with increased tensile strength in the longitudinal direction and also improved fiber retention in the surface, and this is specifically important for adhesive tapes which are sold as roll material without release paper.

Since hand tearability is a subjective variable, it can only be quantified within limits. As described in WO 00/20201 A1, this investigation too is based on a classification which distinguishes between levels of 1—“very poor hand tearability with excessive fraying and ragged tear line” to level 5—“very easy hand tearability with minimal fraying and straight tear line”. The improvement in the transverse tearability on printing with the described binders and geometries ranges from 1 to 4 levels, predominantly from 2 to 3 levels, and is subjectively rated as pronounced.

The determination on trouser-shaped test specimens described in EN ISO 13937-2 “Tear properties of fabrics” provides a satisfactory correlation with the subjective values—but it must be borne in mind that hand tearability is made up of two stages, the direct tear initiation step and the tear propagation step. The above method of measurement only measures the force needed to propagate a defined tear. For this reason, only a rough correlation of the physical measurements with subjective assessments is likely. A good correlation is obtained against the force maxima during the tear propagation step.

Distinct improvements in hand tearability are in the order of 3 to 30 N (difference in force needed to propagate a tear in the base nonwoven to that for the printed nonwoven), preferably on the order of 5 to 20 N. This shows the distinctly smaller force needed to effect tearing through. These values are based on average web weights on the order of 50 to 80 g/m² and have to be appropriately adapted for distinctly different basis weights.

The easier tearability in the transverse direction is accompanied by an improvement in the visual appearance of the tear line—the raw nonwoven gives severely frayed edges and, in the case of markedly longitudinally oriented fiber laydown, tears which to some extent change from the transverse to the longitudinal direction. The stripes print according to the invention—for retention of the fibers with the binder/printing ink—not only markedly reduces fraying but also supports the desired tranverse orientation of the crack propagation process.

There is a positive secondary effect in that the tensile strength in the longitudinal direction increases, which permits a higher load or, for a constant load, a reduction in the basis weight of the nonwoven. Specifically when using hard binders having glass transition temperatures T_{G}>0° C., especially T_{G}>+20° C., the increase in the tensile strength is accompanied by a reduction in the breaking extension. This is an advantage not only for adhesive tape manufacturers but also for many users of the ready-made adhesive tape. The raw nonwovens usually have a flat stress-strain curve—even small loads cause the backing material to stretch substantially and to narrow. This sensitivity leads to fabrication problems not only in the production of adhesive tapes but also in applications such as cable bandaging for example. The printing with longitudinal stripes changes the stress-strain performance in such a way that, in the relevant force range, the extension is less and the curve becomes steeper, it still has the necessary extensibility of a few percentage points. Thus, not only the unwinding from the adhesive tape roll but also the actual processing such as the bandaging of cable harnesses can be carried out without irreversible narrowing or overstretching of the adhesive tape.

A further product advantage, especially when using the backing material as an adhesive tape in the wrapping of cable harnesses, is the improvement in the abrasion resistance of an adhesive tape according to the invention and hence the increased loadability of cable harnesses wound with such adhesive tapes—not only are the fibers specifically at the surface more substantially bound into the nonwoven and hence offer higher resistances to mechanical stress, but also the partial polymer coatings on the backing surface offer by virtue of their film structure favorable preconditions for higher abrasion resistances, especially when the binder polymer is chosen to reflect these requirements and the elastic fraction of the polymer is chosen accordingly for example.

Embodiments of the backing material according to the invention will now be described by way of example without thereby wishing to limit the invention in any way.

### EXAMPLES

The following descriptions illustratively demonstrate for a standard nonwoven backing and a commercially available binder dispersion the improvements in the properties—the results obtained in the lab by flat screen printing are readily transferrable to production processes such as rotative screen printing, intaglio printing and the like by one skilled in the art. The same applies to other backing materials, binders and printing/coating geometries.

The raw nonwoven used is a 64 g/m² hydroentangled backing material composed of 100% PES staple fibers having a linear density of 1.7 dtex and an average fiber length of 40 mm. The nonwoven has an MD: CD ratio of almost 1:1.

The hand tearability in the transverse direction is rated 1 (very poor), and the EN ISO 13937-2 method for determining tear properties on trouser-shaped test specimens gives a tear propagation force of 20.5 N. Fiber pullout is tested using a tesaband® 4651 adhesive tape, which comprises a woven viscose staple fiber fabric backing for high tensile stresses which is polymer coated on its top side and also a resin-modified, soft and very tacky natural rubber adhesive composition, which has a high affinity for the staple fibers. The assessment is against a subjective scale starting at a rating of 1 “very low fiber pullout” to a rating of 5 “very severe fiber pullout”. The above raw nonwoven is rated 4.

### Example 1

The PES nonwoven is flat screen printed with a paste of a thickened dispersion of a commercially available modified polyacrylate having a T_{G} of +32° C. and a viscosity of η=2.5 Pasec (measured at 100 sec⁻¹ rate sweep; SN 1832 cone-plate). To this end, the flat screen is placed on the nonwoven and the paste is squeegeed through a specifically patterned metal screen possessing 80 stripes/inch. The printing geometry consists of stripes 1 mm in width which extend in a parallel arrangement in the longitudinal direction and are spaced 2 mm apart, i.e. an area coverage of 33%. The viscosity chosen provides a predominantly surficial print, although a small degree of binder penetration can be observed. The coating add-on is 16 g/m².

The subjective assessment of hand tearability in the transverse direction indicates an improvement by 3 units for an overall rating of “good”; the EN ISO 13937-2 tear propagation force is 14.8 N. The extensibility behavior of the nonwoven backing changes: the breaking extension decreases by about ⅓ from 49% to 32%. The predominantly surficial print binds the surface fibers of the raw nonwoven better into the surface—the test for fiber retention reveals a significant reduction in the amount of fibers pulled out, by two rating levels, compared with the raw nonwoven. Following one-sided coating on the unprinted nonwoven side with a standard adhesive composition as described for example in EP 0 937 761 A1 the result is an adhesive tape which is very useful for winding and bandaging electric cables to form cable harnesses—the extensibility behavior in response to tensile forces occurring in manual winding permits crease-free, spiral-shaped bandaging, and the adhesive tape is easy to shorten by hand without the aid of a blade or a pair of scissors.

### Example 2

Example 1 is repeated except for the employment of a screen geometry composed of rhombuses about 1 mm in width (in the CD direction) and about 1.5 mm in length (in the MD direction), the rhombuses forming a continuous chain in the longitudinal direction and the respective rhombus tips overlapping to some extent—the distance between the rhombus chains is 1 mm. Area coverage is just short of 40%.

Transverse hand tearability is rated “very good”—the tear propagation force is 11.6 N. Fiber retention improves by 2 to 3 levels to “very good”, whereas the textile hand deteriorates somewhat compared with the raw nonwoven. Breaking extension decreases to 27%.

Performance tests on an adhesive tape similarly to example 1 provide similar results with regard to the bandaging of electric cables into harnesses.

### Example 3

Example 1 is repeated except for a screen pattern composed of MD stripes 0.5 mm in width and spaced 1 mm apart. In addition, supporting stripes 0.3 mm in width are present in the CD direction which are each spaced 6 mm apart. Area coverage is 38%.

Transverse hand tearability is rated “very good”—the tear propagation force is 10.6 N.

Fiber retention improves by 2 to 3 levels to “very good” coupled with minimal losses with regard to textile hand. Compared with example 1, a slight increase in the ultimate tensile strength is measured in the transverse direction.

Performance tests in the form of a coated adhesive tape similarly to examples 1 and 2 provide good results for bandaging electric cables into harnesses.

What is claimed is:

1. Nonwoven-based backing material especially for adhesive tape, comprising a tape-shaped nonwoven-based backing having at least one polymer-base stripe surficially applied to it on either or both of its sides.

2. Backing material as claimed in claim 1, wherein said backing supports a multiplicity of stripes preferably applied in a parallel arrangement.

3. Backing material as claimed in either of claims 1 and 2, wherein said stripes are applied substantially in the machine direction.

4. Backing material as claimed in any of claims 1 to 3, wherein said stripes comprise narrow lines or/and concatenated geometries such as for example rhombuses, ellipses and/or circles.

5. Backing material as claimed in any of claims 1 to 4, wherein said stripes are continuous or interrupted by separations, the distances between the elements being smaller than the lengths of the stripe elements.

6. Backing material as claimed in any of claims 1 to 5, wherein said stripes are from 0.1 mm to 6 mm and especially from 0.5 mm to 3 mm in width.

7. Backing material as claimed in at least one of the preceding claims, wherein the total area of all stripes comprises less than 50% of the total area of said backing, especially from 20 to 40%.

8. Backing material as claimed in at least one of the preceding claims, wherein cross-stripes have been applied to said backing at substantially right angles to said stripes.

9. Backing material as claimed in at least one of the preceding claims, wherein the nonwoven material used is staple fiber web.

10. Backing material as claimed in at least one of the preceding claims, wherein said nonwoven material comprises fibers from 30 to 100 mm in length and/or from 1 to 6 dtex in linear density.

11. Backing material as claimed in at least one of the preceding claims, wherein said stripes are applied by printing technologies such as photogravure or screen printing, by spraying techniques such as inkjet, partial impregnating, pressureless application from a casting head, jet stripe spread coating or knife coating.

12. Backing material as claimed in at least one of the preceding claims, wherein said polymer base used comprises binders, inks, including printing inks, coatings in the form of dispersions or pastes dissolved in organic solvents, as hotmelts or else as reactive systems such as for example radiation-chemically curable coatings, especially having main constituents such as polyacrylates, polyvinyl acetates, polyurethanes, polyesters, styrenic copolymers.

13. Backing material as claimed in at least one of the preceding claims, wherein said polymer base is applied to said backing at from 1 to 80 g/m² and especially at from 3 to 20 g/m².

14. Backing material as claimed in at least one of the preceding claims, wherein a self-adhesive composition has been applied to at least one side of said tape-shaped backing.

15. The use of a backing material as claimed in at least one of the preceding claims for an adhesive tape wherein stripes have been applied to one side of said tape-shaped backing and a self-adhesive composition has been applied, especially uniformly, to the other side, the side opposite the side with said stripe or stripes.

16. The use of a backing material as claimed in either of claims 14 and 15 for wrapping elongate material, such as in particular cable trunks, which comprises said backing material being routed spirally around said elongate material.
